(19) United States
(12) Patent Application Publication
(10) Pub. No.: US 2009/0283296 A1
(43) Pub. Date: Nov. 19, 2009

(54) COAXIAL CABLE

(75) Inventors: Katsuo Shimosawa, Yamanashi (JP); Hajime Ohki, Yamanashi (JP)

Correspondence Address: COLLEN IP, THE HOLYOKE MANHATTAN BUILDING, 80 SOUTH HIGHLAND AVENUE, OSSINING, NY, 10562, US

(73) Assignee: JUNKOSHA INC., Ibaraki (JP)

(21) Appl. No.: 12/159,424

(22) PCT Filed: Dec. 25, 2006
(86) PCT No.: PCT/JP2006/326326

§ 371 Date: Jun. 27, 2008

(30) Foreign Application Priority Data
Dec. 28, 2005 (JP) 2005-380286

(51) Int. Cl. H01B 7/18

(52) U.S. Cl. 174/107

(57) ABSTRACT

As a coaxial cable includes a dielectric layer around a center conductor, an outer conductor layer around the dielectric layer, and a sheath around the outer conductor layer, wherein the dielectric layer is made of unsintered polytetrafluoroethylene, and a metal foil imparting an increased shielding effectiveness and shape maintainability is provided between the dielectric layer made of the unsintered polytetrafluoroethylene and the outer conductor layer, it is possible to make it a high frequency coaxial cable which, having a very excellent low insertion loss, and also having a high shielding effectiveness against a signal leakage increasing an attenuation, can be bent easily and freely by hand without using a tool or the like while effectively maintaining an electrical characteristic for a high frequency signal and, after being bent, has an excellent shape maintainability in that bent condition, enabling an easy wiring work or connecting work by virtue of the excellent shape maintainability.

### TECHNICAL FIELD

The present invention relates to a coaxial cable through which is transmitted a high frequency signal such as one in a microwave band, and particularly to a coaxial cable which, as well as having a flexibility, has a good high frequency characteristic such as a low insertion loss, and furthermore, is provided with an excellent shape maintainability with which, when the coaxial cable is bent, it can effectively maintain that bent condition.

### BACKGROUND ART

To date, as a coaxial cable which transmits a high frequency signal such as one in a microwave band, for example, a coaxial cable used in a base station necessary for communication between portable telephones, or a coaxial cable used for wiring in an instrument such as a measuring instrument, one has been desired which has, as its high frequency characteristics, as well as an impedance stability and a low attenuation, a low insertion loss in addition to an excellent shielding effectiveness against a noise or the like.

Heretofore, as the coaxial cable having the excellent shielding effectiveness, a semi-rigid coaxial cable of a semi-rigid type has been proposed which is formed by providing a dielectric substance made of fluororesin around a center conductor, and providing a copper pipe as an outer conductor around the dielectric substance (for example, refer to JP-A-8-31242). The semi-rigid coaxial cable, as it has the dielectric substance formed of a low permittivity fluororesin, has good high frequency characteristics such as a certain level of low insertion loss and low attenuation, but they are not yet sufficient. Furthermore, at a wiring and assembly time, or when it is necessary to bend the coaxial cable, for example, in order to connect it to an instrument terminal or the like in a predetermined position, as the copper pipe is used as the outer conductor, a shape maintainability of the bent coaxial cable being excellent, it is easy to carry out a wiring work, a connecting work or the like in the position, but there is a problem of requiring a dedicated device such as a tool for the bending.

As opposed to this, as a coaxial cable which has an excellent shielding effectiveness while having a slight flexibility, a semi-flexible coaxial cable of a semi-flexible type has been proposed which is formed by using a dielectric substance made of fluororesin around a center conductor and, as well as providing a metal foil as a flexible shield around the dielectric substance, impregnating a molten metal such as molten tin or solder into a braid provided around the metal foil (for example, refer to JP-A-6-267342).

Although the semi-flexible coaxial cable has a semi-flexibility by limiting a displacement of an insulator relative to the shield by means of the metal foil, as well as connecting the metal foil and the braid by means of the molten metal, in the semi-flexible coaxial cable too, as the dielectric substance is formed of a low permittivity fluororesin, it is possible to expect good high frequency characteristics such as a certain level of low insertion loss and low attenuation, but they are not yet sufficient. Furthermore, when it is necessary to bend the semi-flexible coaxial cable, the semi-flexible coaxial cable having a slightly higher flexibility than the semi-rigid coaxial cable, and also having an excellent shape maintainability of the bent coaxial cable, it is easy to carry out a wiring work, a connecting work or the like in that position, but there is a problem in that a rigidity is still too strong for the bending to be carried out easily and freely by hand due to the connection of the metal foil and the braid by means of the molten metal.

As the coaxial cable having the flexibility, a coaxial cable which, having a flexibility, is configured by sequentially providing a dielectric substance made of fluororesin around a center conductor, providing a braided or served outer conductor around the dielectric substance, and providing a sheath around the outer conductor, is also commercially available and in heavy usage. In this kind of coaxial cable, in the same way as heretofore described, as the dielectric substance is formed of a low permittivity fluororesin, it has good high frequency characteristics such as a certain level of low insertion loss and low attenuation, but they are not yet sufficient, and furthermore, when it is necessary to bend the coaxial cable, it is possible to bend it easily and freely by hand, but there is a problem in that, even when the coaxial cable is bent, the coaxial cable tending to restore its original shape condition due to a spring property combined with the flexibility of the coaxial cable, a shape maintainability maintaining that bent shape is not good. Also, in this kind of coaxial cable, as the outer conductor is braided or served, a shielding effectiveness against a high frequency signal such as one in a microwave band is not sufficient.

### DISCLOSURE OF THE INVENTION

Consequently, the invention having been contrived bearing in mind the heretofore described problems, an object thereof lies in providing a high frequency coaxial cable which, having a very excellent low insertion loss, and also having a high shielding effectiveness against a signal leakage increasing an attenuation, can be bent easily and freely by hand without using a tool or the like while effectively maintaining an electrical characteristic for a high frequency signal and, after being bent, has an excellent shape maintainability in that bent condition, enabling an easy wiring work, connecting work or the like by virtue of the excellent shape maintainability.

The heretofore described object can be achieved by means of the coaxial cable according to the invention. That is, to sum up, the invention is a coaxial cable including a dielectric layer around a center conductor, an outer conductor layer around the dielectric layer, and a sheath around the outer conductor layer, wherein the dielectric layer is made of unsintered polytetrafluoroethylene, and a metal foil imparting an increased shielding effectiveness and shape maintainability is provided between the dielectric layer made of the unsintered polytetrafluoroethylene and the outer conductor layer.

According to the coaxial cable of the invention, as it is made a coaxial cable including a dielectric layer around a center conductor, an outer conductor layer around the dielectric layer, and a sheath around the outer conductor layer, wherein the dielectric layer is made of unsintered polytetrafluoroethylene, and a metal foil imparting an increased shielding effectiveness and shape maintainability is provided between the dielectric layer made of the unsintered polytetrafluoroethylene and the outer conductor layer, in the coaxial cable 10, a relative permittivity and dielectric loss tangent of the dielectric substance are extremely low in comparison with those of sintered polytetrafluoroethylene. As a result thereof, the coaxial cable, as well as having a very excellent low insertion loss, having a high shielding effectiveness against a signal leakage or the like which increases an attenuation, it effectively maintains an electrical characteristic for a high frequency signal while, furthermore, it counteracting shape maintainability resistance members such as the dielectric substance and the sheath by means of the metal foil imparting the shape maintainability along with the center conductor, it is possible to bend the coaxial cable easily and freely by hand without using a tool or the like, and effectively maintain and hold the bent shape condition. As a result thereof, by virtue of the excellent shape maintainability of the coaxial cable, even when the coaxial cable is bent, it not happening that it tends to restore its original shape condition like the heretofore known coaxial cable having the spring property, it is possible to facilitate a wiring work or a connecting work in a desired position, enabling a reduction of labor for the wiring work, connecting work or the like. As the relative permittivity of the dielectric substance is low, in a case in which a diameter of the dielectric substance is the same, it being possible to make the center conductor thicker, it is possible to achieve a lower insertion loss than that of the semi-rigid coaxial cable or the semi-flexible coaxial cable.

### BRIEF DESCRIPTION OF THE DRAWINGS

FIG. 1 is a schematic perspective view of a preferred embodiment of a coaxial cable according to the invention.

FIG. 2 is an illustration of a measuring method which measures a bending shape maintainability of the coaxial cable shown in FIG. 1.

FIG. 3 is an illustration of a measuring method which measures a bent shape maintainability of the coaxial cable shown in FIG. 1.

FIG. 4 is a diagram showing an insertion loss comparison between coaxial cables of examples according to the invention, and coaxial cables of comparison examples.

### BEST MODE FOR CARRYING OUT THE INVENTION

Hereafter, a description will be given, referring to the accompanying drawings, of a coaxial cable according to the invention, based on a preferred embodiment thereof.

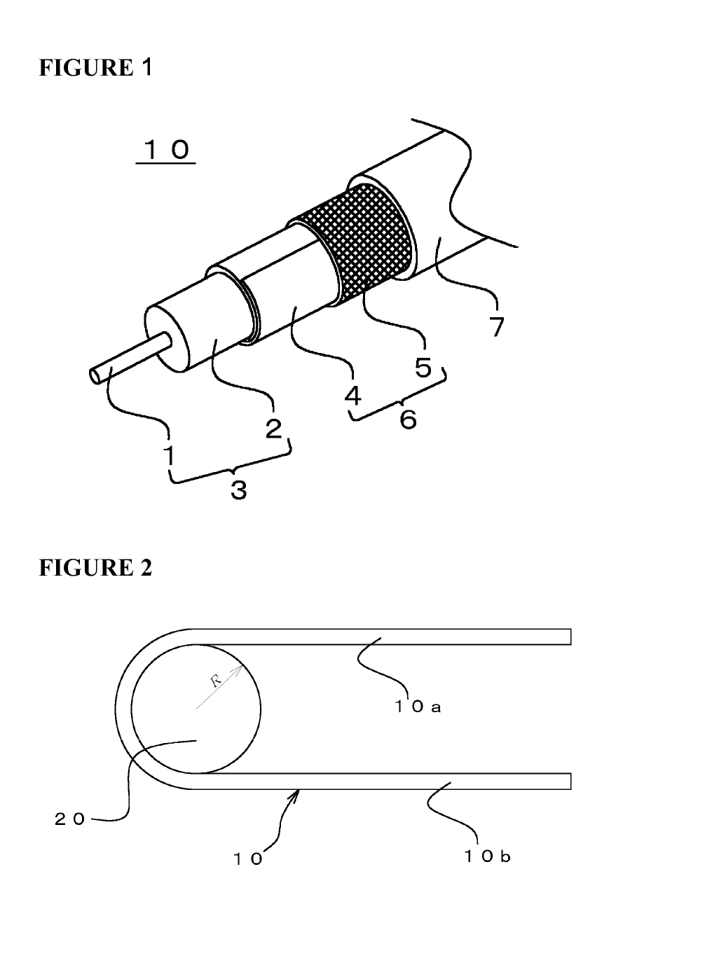

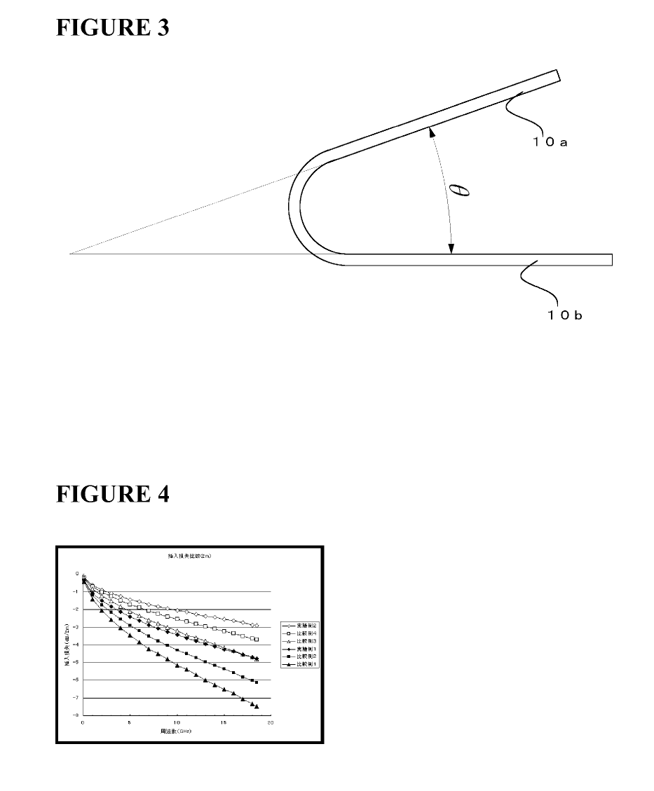

FIG. 1 is a schematic perspective view of the preferred embodiment of the coaxial cable according to the invention. FIG. 2 is an illustration of a measuring method which measures a bending shape maintainability of the coaxial cable shown in FIG. 1, FIG. 3 an illustration of a measuring method which measures a bent shape maintainability of the coaxial cable shown in FIG. 1, and FIG. 4 a diagram showing an insertion loss comparison between coaxial cables of examples according to the invention and coaxial cables of comparison examples. The figures being used only for describing the preferred embodiment of the invention, it should be understood that no dimensions of each portion are taken into account.

Referring to FIG. 1, a coaxial cable 10 according to the invention being shown, in the coaxial cable 10, a dielectric layer 2, made of unsintered polytetrafluoroethylene (PTFE) which, having a low relative permittivity, is fluororesin, is fitted by means of an extrusion molding or the like around a center conductor 1 made of, for example, a single strand, or twisted, silver-plated soft copper wire or silver-plated copper-clad steel wire, forming a core 3.

In order to increase a shielding effectiveness of the coaxial cable 10, as well as imparting the shape maintainability, a metal foil 4, made of a copper foil, an aluminum foil or the like, which has a thickness of a range of 1% to 5%, more preferably, a range of 1% to 3%, of an outer diameter of the dielectric layer 2, that is, a core diameter, is provided around the core 3 in a longitudinally pulled aspect (as a so-called cigarette wrap) in a longitudinal direction of the core 3. The cigarette wrap of the metal foil 4 is wound overlapped with a width having a length of, for example, about 1.1 times to 1.9 times a periphery of the dielectric layer 2 in such a way as to sufficiently cover the periphery of the dielectric layer 2, that is, a core 3 periphery.

Herein, the reason for making the thickness of the metal foil 4 of the range of 1% to 5% of the outer diameter of the dielectric layer 2, that is, the core diameter, is that when making the thickness of the metal foil 4 1% or less of the outer diameter of the dielectric layer 2, the shape maintainability of the coaxial cable 10 being insufficient, no great difference in the shape maintainability is found from the heretofore known coaxial cable having the spring property and having the flexibility, and also that, when making it 5% or more, a rigidity of the coaxial cable 10 being too strong, making it difficult to bend the coaxial cable easily and freely by hand, no difference is found from the heretofore known semi-flexible coaxial cable having the slight flexibility.

As an outer conductor layer 5, a braided layer, or a served layer, made of a conductor strand such as a silver-plated soft copper wire or a silver-plated copper-clad steel wire is formed around the metal foil 4. A conductor layer 6, acting as a shielding layer, is formed by the metal foil 4 and the outer conductor layer 5. The outer conductor layer 5 performs a function of providing the coaxial cable 10 with a higher shielding effectiveness in addition to the shielding effectiveness of the metal foil 4, as well as reliably holding the cigarette wrap of the metal foil 4 without allowing it to unwrap.

A sheath 7 made of molten resin, such as polyvinyl chloride or polyethylene, molten fluororesin, such as tetrafluoroethyline-fluoroalkylvinylether copolymer (PFA) or tetrafluoroethyline-hexafluoropropylene copolymer (FEP), or the like, is fitted around the conductor layer 6 by means of an extrusion molding or the like. As the sheath 7, it is preferable to use a soft resin having a flexibility.

The coaxial cable 10 having the low relative permittivity dielectric substance, fabricated in this way, having a flexibility as a whole, is a coaxial cable for use in, for example, a high frequency, which has an impedance of 50 ohm, and is suitably used in a kind of range of 1 gigahertz (GHz) to 18.5 gigahertz (GHz) in an operating frequency band. As the coaxial cable 10 includes the dielectric layer made of the unsintered polytetrafluoroethylene, by virtue of the metal foil 4 and outer conductor layer 5 which, as well as having a very excellent low insertion loss, impart an increased shielding effectiveness, it having a high shielding effectiveness against a signal leakage or the like which increases an attenuation, it effectively maintains an electrical characteristic for a high frequency signal while, with regard to the shape maintainability of the coaxial cable 10, as the coaxial cable 10 includes the metal foil 4 imparting the shape maintainability, it is possible to bend the coaxial cable 10 without using a tool or the like, and furthermore, easily and freely by hand unlike the heretofore known semi-flexible coaxial cable, as a result of which it is possible to effectively maintain a shape condition of the bent coaxial cable 10. Consequently, because of the excellent shape maintainability of the coaxial cable, even when the coaxial cable is bent, it not happening either that it tends to restore its original shape condition like the heretofore known coaxial cable having the spring property, it is possible to facilitate a wiring work, a connecting work or the like in a desired position, enabling a reduction of labor for the wiring work, connecting work or the like.

### EXAMPLE 1

As an example 1, the coaxial cable according to the invention is fabricated in conformity with the U.S. MIL Standard M17/133-RG405 (UT85). That is, as the dielectric layer 2, unsintered PTFE is fitted and formed by means of an extrusion molding or the like around a center conductor 1 which, having a diameter of 0.60 mm, is made of a single strand of silver-plated soft copper wire, forming a core 3 having a diameter of 1.73 mm. A soft copper foil 4 having a thickness of 0.035 mm and a width of 6.7 mm is wound around the core 3, overlapped 1.23 times as a cigarette wrap, in the longitudinal direction of the core 3 in such a way as to sufficiently cover the core 3 periphery. An outer conductor layer 5 (2.19 mm in outer diameter) in which a tin-plated soft copper wire 0.08 mm in strand diameter is braided with 4 ends and 16 picks is formed around the soft copper foil 4, and FEP is fitted and formed as the sheath 7 around the outer conductor layer 5 by means of an extrusion molding or the like, fabricating a coaxial cable 10 for an operating frequency of 18.5 GHz which has an outer diameter of 2.49 mm and an impedance of 50 ohm.

### COMPARISON EXAMPLE 1

As a comparison example 1, a semi-flexible type coaxial cable complying with the U.S. MIL Standard M17/133-RG405 (UT85) is fabricated. That is, as the dielectric layer 2, PTFE is fitted and formed by means of an extrusion molding or the like around a center conductor 1 which, having a diameter of 0.51 mm, is made of a single strand of silver-plated copper-clad steel wire, and sintered to form a core 3 having a diameter of 1.59 mm. An outer conductor layer 5 in which a soft copper wire 0.08 mm in strand diameter is braided with 4 ends and 16 picks is formed around the core 3, and a tin coat is applied to the outer conductor layer 5 to make an outer diameter of 2.10 mm, around which FEP is fitted and formed as the sheath 7 by means of an extrusion molding or the like, fabricating a coaxial cable 10 for an operating frequency of 18.5 GHz which has an outer diameter of 2.7 mm and an impedance of 50 ohm.

### COMPARISON EXAMPLE 2

As a comparison example 2, a semi-rigid type coaxial cable complying with the U.S. MIL Standard M17/133-RG405 (UT85) is fabricated. That is, as the dielectric layer 2, PTFE is fitted and formed by an extrusion molding or the like around a center conductor 1 which, having a diameter of 0.51 mm, is made of a single strand of silver-plated copper-clad steel wire, and sintered to form a core 3 having a diameter of 1.68 mm. A copper tube is fitted around the core 3, and an outer conductor layer 5 is formed by means of a tube withdrawal, fabricating a coaxial cable 10 for an operating frequency of 18.5 GHz which has an outer diameter of 2.10 mm and an impedance of 50 ohm.

### EXAMPLE 2

As an example 2, the coaxial cable according to the invention is fabricated in conformity with the U.S. MIL Standard M17/130-RG402 (UT141). That is, as the dielectric layer 2, unsintered PTEF is fitted and formed by an extrusion molding or the like around a center conductor 1 which, having a diameter of 1.0 mm, is made of a single strand of silver-plated soft copper wire, forming a core 3 having a diameter of 2.99 mm. A soft copper foil 4 having a thickness of 0.04 mm and a width of 12 mm is wound around the core 3, overlapped 1.25 times as a cigarette wrap, in the longitudinal direction of the core 3 in such a way as to sufficiently cover the core 3 periphery. An outer conductor layer 5 (3.57 mm in outer diameter) in which a tin-plated soft copper wire 0.102 mm in strand diameter is braided with 6 ends and 16 picks is formed around the soft copper foil 4, and FEP is fitted and formed as the sheath 7 around the outer conductor layer 5 by an extrusion molding or the like, fabricating a coaxial cable 10 for an operating frequency of 18.5 GHz which has an outer diameter of 3.97 mm and an impedance of 50 ohm.

### COMPARISON EXAMPLE 3

As a comparison example 3, a semi-flexible type coaxial cable complying with the U.S. MIL Standard M17/130-RG402 (UT141) is fabricated. That is, as the dielectric layer 2, PTFE is fitted and formed by an extrusion molding or the like around a center conductor 1 which, having a diameter of 0.91 mm, is made of a single strand of silver-plated copper-clad steel wire, and sintered to form a core 3 having a diameter of 2.86 mm. An outer conductor layer 5 in which a soft copper wire 0.102 mm in strand diameter is braided with 4 ends and 24 picks is formed around the core 3, and a tin coat is applied to the outer conductor layer 5 to make a diameter of 3.45 mm, around which FEP is fitted and formed as the sheath 7 by an extrusion molding or the like, fabricating a coaxial cable 10 for an operating frequency of 18.5 GHz which has an outer diameter of 4.1 mm and an impedance of 50 ohm.

### COMPARISON EXAMPLE 4

As a comparison example 4, a semi-rigid type coaxial cable complying with the U.S. MIL Standard M17/130-RG402 (UT141) is fabricated. That is, as the dielectric layer 2, PTFE is fitted and formed by an extrusion molding or the like around a center conductor 1 which, having a diameter of 0.91 mm, is made of a single strand of silver-plated copper-clad steel wire, and sintered to form a core 3 having a diameter of 2.98 mm. A copper tube is fitted around the core 3, and an outer conductor layer 5 is formed by means of a tube withdrawal, fabricating a coaxial cable 10 for an operating frequency of 18.5 GHz which has an outer diameter of 3.60 mm and an impedance of 50 ohm.

Insertion losses of the coaxial cables of the examples, and the coaxial cables of the comparison examples, fabricated in this way, are measured using a “network analyzer” made by “Anritsu” Corporation, and results thereof are shown in FIG. 4.

As can be seen from FIG. 4, in the group of the U.S. MIL Standard M17/130-RG402 (UT85), it turns out that the insertion loss of the coaxial cable of the example 1 according to the invention is smaller than those of the semi-flexible type coaxial cable of the comparison example 1, and the semi-rigid type coaxial cable of the comparison example 2. In the same way, in the group of the U.S. MIL Standard M17/130-RG402 (UT141), it turns out that the insertion loss of the coaxial cable of the example 2 according to the invention is smaller than those of the semi-flexible type coaxial cable of the comparison example 3, and the semi-rigid type coaxial cable of the comparison example 4.

Next, the shape maintainability of the coaxial cables of the examples, and the coaxial cables of the comparison examples, is checked by the kinds of method shown in FIGS. 2 and 3.

That is, as shown in FIG. 2, the coaxial cable 10 of each example 1 and 2 according to the invention is wound on a mandrel 20 having a radius (R) of 18 mm, and bent 180 degrees by applying pressure to extremes of upper and lower coaxial cables 10a and 10b with the mandrel 20 mediated between them in such a way that the coaxial cables 10a and 10b are approximately parallel. After the bending, as shown in FIG. 3, when making the extremes of the coaxial cables 10a and 10b free ends, and measuring an angle θ formed by the lower coaxial cable 10b and the upper coaxial cable 10a, the angle θ of the coaxial cable 10 according to the invention being about 15 degrees, about 15 degrees is obtained, which is said to provide an excellent shape maintainability.

When bending the semi-rigid type coaxial cables of the comparison examples 2 and 4, there is a problem in that a dedicated device such as a tool is indispensable due to their rigidity. As opposed to this, as a result of measuring the shape maintainability of the semi-flexible type coaxial cables of the comparison examples 1 and 3 by the same method as heretofore described, the angle θ of the semi-flexible coaxial cables of the comparison examples 1 and 3 being about 15 degrees, at which the shape maintainability is effective, their shape maintainability is approximately the same as that of the coaxial cables of the invention, but there is a rigidity in their bending around the mandrel 20, resulting in difficulty bending them by hand.

As a result of measuring the shielding effectiveness of the coaxial cables of the examples 1 and 2 according to the invention, and that of the coaxial cables of the comparison examples 1 and 2, using a network analyzer (made by Agilent Technologies, Inc.), no special difference is found between the two.

### INDUSTRIAL APPLICABILITY

The coaxial cable of the invention being one which transmits a high frequency signal such as one in a microwave band, as it is made a coaxial cable which, as well as having a very excellent low insertion loss and flexibility, when being bent, has an excellent shape maintainability which effectively maintains a shape in that bent condition, it is possible to suitably use it as, for example, a coaxial cable used in a base station necessary for communication between portable telephones, or a coaxial cable used for wiring in an instrument such as a measuring instrument.

1. A coaxial cable comprising:
a dielectric layer around a center conductor;
an outer conductor layer around the dielectric layer; and
a sheath around the outer conductor layer, wherein
the dielectric layer is made of unsintered polytetrafluoroethylene, and
a metal foil imparting an increased shielding effectiveness and shape maintainability is provided between the dielectric layer made of the unsintered polytetrafluoroethylene and the outer conductor layer.

2. The coaxial cable according to claim 1, wherein
a thickness of the metal foil is in a range of 1% to 5% of an outer diameter of the dielectric layer made of the unsintered polytetrafluoroethylene.

3. The coaxial cable according to claim 1, wherein
between the dielectric layer made of the unsintered polytetrafluoroethylene and the outer conductor layer, the metal foil is disposed, longitudinally pulled, around the dielectric layer made of the unsintered polytetrafluoroethylene.

4. The coaxial cable according to claim 1, wherein
the outer conductor layer is a braid.
